(19) United States
(12) Patent Application Publication
(10) Pub. No.: US 2001/0040434 A1
(43) Pub. Date: Nov. 15, 2001

(54) FREE ELECTRON CONDENSATION VOLTAGE GAIN DEVICE

(76) Inventor: LAWRENCE L. NELSON, ARVADA, CO (US)

Correspondence Address: LAWRENCE NELSON, NELSON SCIENTIFIC, PO BOX 50774, COLORADO SPRINGS, CO, 80949-0774, US

(21) Appl. No.: 09/358,746

(22) Filed: Jul. 21, 1999

Related U.S. Application Data
(60) Provisional application No. 60/093,789, filed on Jul. 23, 1998.

(51) Int. Cl. H01J 21/00

(52) U.S. Cl. 315/1

(57) ABSTRACT

The present invention provides a method and apparatus useful for providing a voltage gain as well as for generating energy. The anomalous lack of repulsion observed between unbound electrons is exploited by the apparatus, which comprises an electron gun and a capacitor which is charged by free electrons and is discharged by a circuit. The preferred embodiment additionally comprises a magnetic bottle which is activatable.

### BACKGROUND OF THE INVENTION

Currently, useful energy is derived from energy stored in chemical or nuclear bonds, or converted from energy existent in the surrounding environment. The former includes such sources of energy as fossil fuels, nuclear energy, and batteries. These have the disadvantage of producing waste products. The latter group includes sun, wind and water, which are converted to useful energy through the use of solar panels, wind turbines and hydroelectric dams. These sources suffer from sporadic and intermittent availability.

Electron guns and magnetic bottles have been around for a while, but have not previously been considered as a possible source for the generation of useful energy, or as being a useful method whereby a voltage gain might be obtained.

Electron guns are commonly used in cathode ray tubes for televisions, for example. They operate by heating a cathode so that it emits free electrons from its surface, which are then accelerated through a grid or aperture to form a cathode ray. More recent developments in the art make use of materials with lower work functions, which enables the freeing of electrons at lower energies, at the surface of the cathode, using materials such as diamond or graphite, which are different structural forms of carbon, and a confined volume of electrical field to free the electrons from the cathode without heating the cathode. Such cathodes are therefore referred to as cold cathodes.

Magnetic bottles are commonly used in devices such as the synchrotron experimental device. A magnetic field is formed so that its lines of flux are convergent at either end of a central region of lower flux. Such a magnetic field will serve to trap electrons within the central region by causing the path of electrons which wander towards the ends to re-orient back towards the central region.

The discoveries leading to the current innovation of using electron guns and magnetic bottles to provide energy, and, as an intermediate benefit, to provide a means for generating a voltage gain, were first made by Thomas Edison.

While working on the development of the incandescent light bulb, Thomas Edison placed a metal plate near one of the incandescent filaments inside the vacuum of the bulb, such filaments acting as cathodes. Using an ammeter, he measured a very small current flowing between the filament and the plate. He further noticed that the current abated over time, eventually falling to zero. If he introduced a small voltage between the plate and filament the current returned to its initial value and continued even after that voltage was again removed.

The abatement of electrical current has been explained as being caused by the effects of momentum transfer. As the escaping electrons would display a Fermi-Dirac energy distribution, the more numerous “slow” electrons would collect in the vicinity of the cathode, forming an “electron cloud”. Newly escaping electrons would collide with this cloud, and the momentum transfer that occurred during this collision would act to slow the escaping electrons, thus causing the abatement in current.

Edison's observations contradicted the current understanding of theoretical physics with respect to the electrical properties of free electrons. According to theoretical physics, free electrons should repel each other. However, the formation of a stable cloud configuration of free electrons contradicts this.

The energy of the freed electrons can be obtained from the equation for the density of electron energies. The electrons inside the metal of the cathode will show an energy distribution as specified by the Fermi-Dirac equation, so the density of electrons having energy ω, as given by N(ω), will therefore be given by:

N(ω)dω=(8π/h³)(2m³w)^{½}[exp((ω−ω_{f})/kT)+1]⁻¹dω

where:

N(ω)=the density of electrons having energy ω

This equation represents the distribution of the energy densities of the electrons inside the cathode. The energy boundary the electrons will need to overcome in order to escape the cathode is ω_{B}.

The energy distribution of the escaping electrons will be given by:

Nₑ(ω)dω=N(ω+ω_{B})dω

h=Planck's constant

m=electron mass

T=temperature in degrees Kelvin

For a cathode at 3000° K producing a current of 1 mA, there are only about 10¹³ electrons per cubic meter, or 10⁻¹³ times the density of air at standard temperature and pressure, traveling at about 10⁻³ times the speed of light. The electrical potential that would result from the electron density of the current would be on the order of 1.5V while the electrons would be emitted with energies on the order of 0.25 V.

By the predictions of classical electrodynamics, before the electrons would have a chance to build up to densities that would make them likely to interact through collisions, the potential in the space between the filament and the electrode would become enormous (10⁸ for electron densities only 1% that of air). In other words, classical theory would predict that no electron cloud would build up, as the repulsion between the electrons of a potential cloud would serve to dissipate it.

The observations made by Edison, which have been replicated in experiments with vacuum tube diodes, prove these classical assumptions do not hold under the experimental conditions.

### SUMMARY OF THE INVENTION

The experimental results seen by Edison suggest the development of a device that in a simple embodiment may be used to provide voltage gain, and, with the addition of commonly used circuitry, may be used to generate energy.

The basic device consists of a cathode ray that is used to generate free electrons and a magnetic bottle that traps them in a surrounding conducting enclosure that acts as one plate of a capacitor. A conducting enclosure can be defined as any enclosure fabricated of a conducting material such as a metal or metallic compound, examples including copper or aluminum. Ground or a second conducting enclosure will act as the other plate of the capacitor. The region encompassing the electron gun and magnetic bottle are maintained in a vacuum so that interactions with gas molecules can be neglected. The Edison experiment, as well as more recent experiments, suggest that the electric field attributed to electrons is dependent on the binding state of the electrons. As unbound electrons do not repel each other as strongly as those bound to a conductor, the measured voltage of the conducing enclosure, once the electrons are released from the magnetic bottle and allowed to interact with it, will be greater than the accelerating voltage of the cathode ray. Therefore, this device can be used to provide voltage gain. This voltage gain can be anything from less than 1 to a theoretically infinite gain; however, the most common voltage gain will be approximately 500%, though other values can be attained.

The device can further be used to generate energy. A certain amount of power is required to heat up the cathode so that it will generate electrons for the case in which the electron gun is a cathode ray tube. Other types of electron guns may also be used, such as cold cathode tubes, but regardless of what is used to generate an electron stream, a certain amount of power is required to generated electrons. However, by connecting a circuit providing a path to ground to the charged conductor enclosing the magnetic bottle, which acts as a capacitor, a current is generated. When this current is drawn through a load, power is generated. The means for heating the cathode ray might be electric, but it can also be another form of energy, such as steam, solar, or water heated by fossil fuels, thus allowing a conversion from one form of energy to another. In the event that electric power is used to generate a stream of electrons from the electron gun, the power generated by the device can be greater than the power used to generate the stream of electrons for reasons which are shown in the description below.

### BRIEF DESCRIPTION OF THE DRAWING

The various figures of the drawing describe embodiments of the invention.

FIG. 1 of the drawing is an embodiment of the invention that can be used as a voltage gain device.

FIG. 2 of the drawing is an embodiment of the invention that generates electricity. In this embodiment, two sets of magnets are used.

FIG. 3 of the drawing is the preferred embodiment for generating electricity.

FIG. 4 of the drawing is an embodiment using several capacitors to generate heat.

FIG. 5 of the drawing is an embodiment using several capacitors to generate electricity.

FIG. 6 of the drawing is an embodiment using a semi-spherical cold cathode as an electron gun.

### DETAILED DESCRIPTION OF THE DRAWING

Classical physics indicated that in a magnetic field, a moving electron will travel in a circular path perpendicular to the magnetic field. Given a magnetic field, B, and a constant, k, which is dependent on the momentum and charge of the free electron, the radius, r, of the free electron's path may be represented by:

r=k/B

As can be seen from the above equation, as the strength of the magnetic field decreases, the physical dimensions of the magnetic bottle increase. When the surface of the magnetic bottle is no longer contained within the surface of a capacitor which encloses the magnetic bottle, the electrons will impact the surface of the capacitor and become bound by the atoms of the material forming the capacitor. Thus a charge will form on the capacitor.

A current may be caused to flow by connecting the charged capacitor to circuitry that will connect it to ground. A cycle is created whereby the capacitor is charged and discharged by means of controlling the radius of the magnetic bottle. During phase I of the cycle, the magnetic field generated is large enough so that the radius of the magnetic bottle is small enough so that electrons contained in the magnetic bottle will not collide with the enclosing capacitor. During phase II of the cycle, the magnetic field is small enough so that the radius of the magnetic bottle will overlap with the capacitor and therefore the electrons will charge the capacitor.

The potential of the electron cloud given a constant velocity for the electrons emitted from the electron gun is determined in the following manner. Cylindrical coordinates are used, which specify location in terms of radius and angle, vs. x-y coordinates, for the sake of simplicity. The initial charge density for the free electrons will be:

(2πrlρ)dr=I dt

where r is the radius of a cylindrical volume centered about a line of charge, ρ is the density per unit volume of the electrons, l is the length of the source, and I is the total current. As I represents the flow of electrons, its value will be negative. Solving for ρ:

ρ=−I/(2πrlv),

where v=dr/dt.

Then,

∇² V=(1/r)(d/dr)(r(d/dr)V)=ρ/εₒ=−I/(2πεₒrlv)

where V is the voltage and εₒ is the permitivity constant for free space.

This equation will have solutions of the type:

Ar+B ln(r/rₒ)+C

where A, B and C are constants and rₒ is the distance to the surface of the cathode from the center of a spherical volume centered about a point charge. The first term represents the electron cloud, the second term represents the induced charge at the cathode source when the source is grounded, and the third term is a constant specific to a particular situation.

V=Ar+B ln(r/rₒ)+C

This then produces, for A:

A=−I/(2πεₒlv)

The boundary conditions are that the voltage is zero at the surface of the cathode (r=rₒ) and at the outer radius of the electron tube (r=R). Solving for B and C given these boundary conditions produces:

B=(I/(2πεₒlv))((R−rₒ)/ln(R/rₒ))

C=Irₒ/(2πεₒlv)

This produces an equation for the potential of the electron cloud:

V(r)=(I/(2πεₒlv))[((R−rₒ)/ln(r/rₒ)−(r−rₒ)]

Solving for a current of 1 mA, a cathode heated to 2000° K, a cathode radius of 1 mm and an anode radius of 3 mm, the minimum voltage would be 0.41 V. The thermal energy in this case, which will be 3 kT/2, is 0.26 eV. In this situation, the electrons emitted will have a temperature of 3000° K.

To calculate the energy gain cutoff when using a cathode ray, we set the energy consumed to the energy generated:

P_{—}=Pₘ+Pₕ+Pₐ=Pₘ+VₕIₕ+VₐI_{c}

Where:

Pₘ=the power consumed by the magnets

P_{c}=power consumed to accelerate the cathode ray

Vₕ=driving voltage for the cathode heater, typically 6.3 V

Iₕ=current draw of the cathode heater, typically 0.95 A

Vₐ=anode voltage, typically 200V

I_{c}=cathode current, typically around 10 mA.

The power generated is equal to:

P₊=E/T=(T/8C)I_{c}²

where:

T=the period during which current is drawn from the capacitor

C=the capacitance of the capacitor

I_{c}=the current drawn from the capacitor

When P₊>P₋ then the system has a positive energy flow. This would occur for:

T>[Pₘ+VₕIₕ+VₐI_{c}](8C/I_{c}²)

Given the following typical values:

Pₘ=0.5 Watt

Vₕ=6.3V

Iₕ=0.9 A

Vₐ=200V

I_{c}=10 mA

C=100 pF

T=0.52 milliseconds

The capacitor voltage would be 52 kV. The actual power generated will depend on the efficiency of the circuitry that utilizes this power.

We are claiming a device for providing voltage gain comprising an electron gun positioned such that its output is captured by a magnetic bottle which is enclosed by a conducting enclosure. By voltage gain we mean that, if the input has a value of α Volts, the output will have a value of κα Volts, where κ is a real number. An electron gun is any device, such as a hot or a cold cathode, combined with acceleration means such as a wire grid or plate with an aperture maintained at an accelerating voltage, which is capable of generating a stream of electrons. A magnetic bottle refers to a “container” defined by magnetic fields. Such a “container” does not have a physical presence per se, but due to the magnetic fields being generated, will contain, or enclose, charged particles such as electrons within the space defined by these magnetic fields. The voltage gain of such a device can be any real number, though the most common one will be approximately 5 (for a voltage gain of 500%). The magnetic bottle is intermittently activatable; the magnets that generate the magnetic fields that create the magnetic bottle are able to be turned off and on.

We are also claiming a device for generating energy comprising an electron gun positioned such that its output is directed towards a magnetic bottle, said magnetic bottle being enclosed by a capacitor. When we say that the electron gun is positioned such that its output is directed towards the magnetic bottle, we mean that the electron gun is positioned such that a significant portion of the electrons it generates will enter into, and be contained by, the magnetic bottle. The magnetic bottle itself can be generated by a set of passive magnets (magnets that are always on) in conjunction with a set of intermittently activatable magnets (magnets that can be turned on and off through some control signal such as a current), or the magnetic bottle can be generated solely by activatable magnets. When passive and activatable magnets are used, the activatable magnets generate fields that exactly opposes the fields generated by the passive magnets. By exactly oppose, we mean that when the fields generated by the passive magnets are broken down into their respective components, so that they can be described by:

Ax+By+Cz=B_{P}

where A, B, and C are constants, and B_{P} is the total magnetic field generated by the passive magnets, the fields generated by the activatable magnets is:

−Ax−By−Cz=B_{A}

In other words, the fields generated by the activatable magnets are of the same absolute value, but in opposite direction to, the fields generated by the passive magnets.

Alternatively, the magnetic bottle can be intermittently generated by activatable magnets, without the use of passive magnets. By intermittently generated, we mean that the magnetic field generating the magnetic bottle is turned on and off in a periodic fashion. The length of time that the field is on is ideally the length of time required for the electron gun to generated the maximum amount of charge that the conducting enclosure can practically sustain. The length of time that the field is off is ideally the length of time required for the conducting enclosure to discharge. Since an electronic circuit is used for coordinating the turning on and off of the field in conjunction with discharging the conducting enclosure, this process will be periodic.

A focusing means can be placed between the electron gun and the magnetic bottle to better aim, or focus, the output of the electron gun so that it enters into, and is captured by, the magnetic bottle. The focusing means can be a set of lenses, or any other means that will serve to direct the output of the electron gun. This focusing means can be mobile, so that the angle it directs the output of the electron gun can be changed. This latter function is particularly useful in the event that a plurality of capacitors is used to capture the output of the electron gun. This is a separate embodiment of the invention.

In the embodiment using a plurality of capacitors a magnetic bottle is not used. Instead, the electron gun generates electrons which are aimed by the focusing means towards one of a plurality of capacitors. The capacitors are charged for a time period, then the focusing means re-focuses the output of the electron gun to another capacitor, and the first capacitor is discharged. Discharging the capacitor generates a current which can be used to provide power to electrical devices by being routed through conversion circuitry which will convert it into a form usable to such devices.

A deflector plate can also be used in addition to the focusing means. The deflector plates are defined as a set of plates that deflect or repel electrons. One method whereby all the capacitors are serially charged and discharged is for the capacitors to be arranged in a semi-circle, and the focusing means would direct the electron beam to the capacitors in order from first to last, then goes from the last capacitor back to the first and starts the process again. A slight modification of this embodiment will allow the generation of heat.

To generate heat, the current generated when the capacitors are discharged is not used to drive circuitry, but is routed through a heat generating load, such as a resistive element such as a resistor.

Another embodiment for generating energy not requiring a magnetic bottle is one in which a semi-spherical cold cathode is used positioned such that its output significantly converges upon a conducting enclosure.

While normally an electronic means is used to power the electron gun, other means such as solar energy or heat from burning a fossil fuel can be used to heat the electron gun, thus allowing electricity-generating embodiments to convert energy from one form to another.

As can be seen, there are four possible functions the various embodiments of this invention can serve. One is to provide a voltage gain, the method for which consists of positioning an electron gun to provide an electron stream aimed at a magnetic bottle. The magnetic bottle is enclosed by a conducting enclosure. When the electron gun is activated, the electrons form a cloud within the magnetic bottle. When the magnetic fields creating the magnetic bottle are weakened sufficiently so that the outer surface of the magnetic bottle encounters the conducting enclosure, the conducting enclosure is charged, creating a voltage with respect to ground. Note that the easiest way to weaken the magnetic fields is simply to reduce them to zero. Voltage detection circuitry can be used to detect the voltage with respect to ground, and this is the output voltage of the voltage gain device. The input voltage is the voltage connected to the electron gun.

A second function is to provide electrical current. There are two methods for doing this. One is to use an electron gun aiming its output at a magnetic bottle. A conducting enclosure surrounds the magnetic bottle. In a process similar to the one described above, the magnetic bottle is dissipated and the conducting enclosure is charged. When the conducting enclosure is discharged, a current is generated. This current is routed through a conversion circuit to provide either a current or a voltage in a form usable for various electronic applications.

The other method for providing electrical current uses the electron gun and a conducting enclosure, or a plurality of capacitors without the magnetic bottle. In this situation, the timing of the electron discharge is controlled either through the slow rate of electron generation by the electron gun, or, in the case of a plurality of capacitors being used, one capacitor is discharged while another is being charged.

The invention also teaches a method for generating heat. Such a method comprises positioning an electron gun able to provide an electron stream such that the stream is directed either into a magnetic bottle enclosed by a conducting enclosure, or directly into either a conducting enclosure or a plurality of capacitors. When the conducting enclosure or capacitors are discharged, the current is then routed through resistive elements so that heat is generated.

Finally, a method for converting one form of energy into another is taught. The method used for generating heat is one variant of this method as electricity can be used to power the electron gun in this method. Another variant of this method is identical to the method for providing electrical current; however a non-electric energy source is used to provide energy to the electron gun. Solar energy, for example, can be used to heat the electron gun. Thus, solar energy is converted to electricity. Other forms of non-electric energy, such as heat generated from burning fossil fuels, can also be used.

When electric energy is generated by the invention, it can be routed through a conversion circuit that converts it into a form usable by whatever item is desired to be powered by the electricity. Examples of possible items that can be powered by this invention include means of transportation, such as cars, buses, trains, or planes; household appliances, such as television sets or microwaves; satellites; city power grids; greenhouses; water purification systems, such as city water systems or water systems for individual homes; waste disposal systems such as city disposal systems; home heating systems, which include radiators using electric heat and also heat pumps or systems whereby hot water is heated using the invention; and steam turbines.

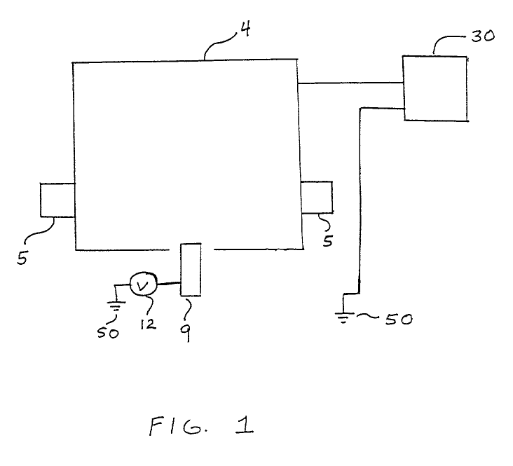

FIG. 1 shows the embodiment of the invention that can be used as a voltage gain device. 9 is an electron gun, such as a hot or cold cathode tube. It is positioned such that its output is directed into the conducting enclosure 4. A set of activatable magnets 5 creates a magnetic bottle which captures the electrons that are produced by the electron gun 9. When the magnetic field generated by the magnets 5 is sufficiently strong, the surface of the magnetic bottle is contained wholly within the conducting enclosure 4, and the captured electrons form an electron cloud within the conducting enclosure 4. When the magnetic field generated by the magnet is lessened, the surface of the magnetic bottle is no longer contained within the conducting enclosure, and the electrons that were within the electron cloud collide with and are captured by the conducting enclosure. When the electrons are captured by the conducting enclosure, a negative voltage is induced upon the conducting enclosure which can be measured by an appropriate device 30 relative to ground 50. The voltage 12 required to activate the electron gun is the input voltage and the ratio of the output voltage to the input voltage is the voltage gain ratio of the device. This ratio can be modified depending on the time period for which the electron gun is active, the capacitance of the conducting enclosure, the input voltage, etc. A typical value for this gain ratio is 5, but any value from 0 to infinity is theoretically possible.

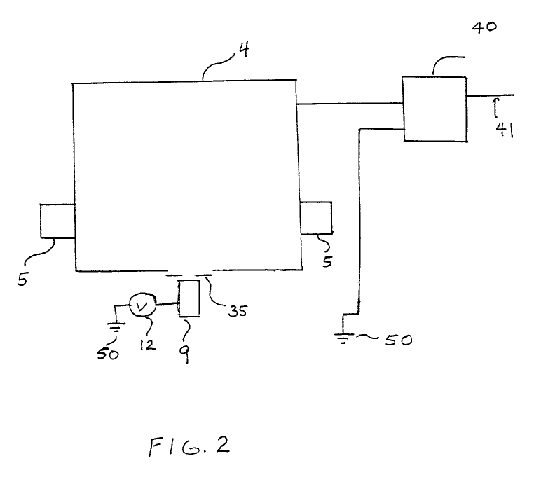

FIG. 2 shows an embodiment of the invention that can be used to generate electricity. An electron gun 9 is positioned such that its output is directed into the conducting enclosure 4. A focusing means 35 can be used to focus the electron stream produced by the electron gun. This focusing means is optional. It can be a set of lenses, or a set of focusing plates and accelerating plates. A set of activatable magnets 5 is used to create a magnetic bottle within the conducting enclosure when the magnetic field generated is sufficiently strong. When the magnetic field is strong enough, the surface of the magnetic bottle is wholly contained within the conducting enclosure and the electrons generated by the electron gun form an electron cloud within the conducting enclosure. When the magnetic field is weakened, the electron cloud is dissipated and its electrons collide with and are captured by the conducting enclosure, inducing a voltage. A conversion circuit 40 is connected to the conducting enclosure 4 and will convert the induced voltage into an electric current which can be connected through output line 41 to various electronic devices. 12 is the voltage provided to the electron gun, and 50 is ground.

The operation of this device occurs in two phases. During Phase I, the magnetic field is strong enough to create a magnetic bottle wholly contained by the conducting enclosure. The electron gun is active, and generates a stream of electrons which are captured by the magnetic bottle and form an electron cloud within the magnetic bottle. During Phase II, the magnetic field is weakened so that the surface of the magnetic bottle is no longer contained by the conducting enclosure. The magnetic field can be weakened to zero, or any value sufficiently low enough to cause the surface of the magnetic bottle to no longer be contained by the conducting enclosure. During Phase II, the electron gun is turned off. The electrons that formed an electron cloud during Phase I collide with the conducting enclosure during Phase II, and are captured by the conducting enclosure, causing a voltage to be induced. During the next Phase I, the conducting enclosure is discharged by the conversion circuit. This can be done by closing a switch that provides a connection to ground. The conversion circuit uses the current generated by discharging the conducting enclosure to provide an electrical current to any device or devices connected to the conversion circuit.

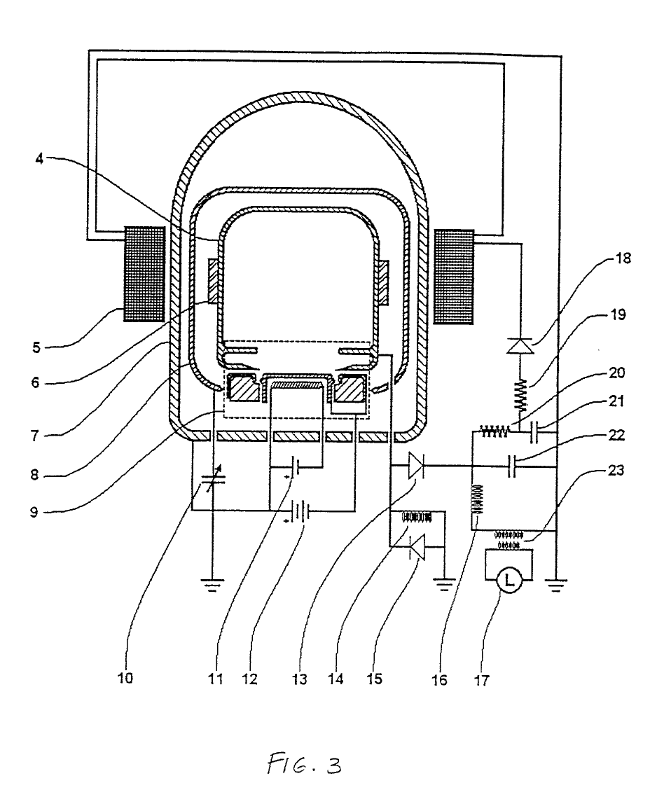

FIG. 3 shows the preferred embodiment of the invention used to generate electricity. The electron gun 9 is positioned such that its output will be generated towards the magnetic bottle created by the two sets of magnets, 5 and 6. These magnets can be electromagnets, or any other type of magnets and accompanying circuitry that will produce the desired magnetic fields. The first set of magnets 6 is permanently on. The second set of magnets, 5, is intermittently activated. The electron gun 9 is maintained at a constant voltage. Typically, this voltage will be in the range of, though not limited to, −2 to −2000 Volts. Conducting enclosure 4 acts as one plate of a capacitor. A second conducting enclosure 8 acts as the second plate of the capacitor and is connected to ground 50 through a second capacitor 10. 7 is a vacuum chamber and is made of conductive material such as metal or metal surrounding a ceramic chamber, and is connected to ground in order to shield unwanted EMF radiation and prevent electrical breakdown of surrounding air molecules. 11 and 12 are two voltage sources used to provide power to the electron gun and activatable magnets.

During Phase I of operation, the second set of magnets 5 is turned off, and the electrons generated by the electron gun 9 are captured by the magnetic bottle created by the first set of magnets 6. While the second set of magnets 5 is turned off the conducting enclosure 4 is connected to ground via an inductor 14. The electrons which are not contained by the magnetic bottle, but which collide with the conducting enclosure 4, are drained to ground through the inductor 14, which will permit drainage of charge as long as the current produced by the drainage does not change too rapidly.

During Phase II of operation, the second set of magnets 5 are turned on and create a magnetic field in opposition to the magnetic field created by the first set of magnets 6. Therefore, the magnetic bottle is dissipated, and the electrons contained by the magnetic bottle are rapidly released, colliding with the conducting enclosure 4, causing it to become rapidly negatively charged. An equal positive charge is induced on second conducting enclosure 8, which acts as the other plate of the capacitor. This negative charge cannot be accommodated by the inductor 14, and is instead the current is forced through diode 13. (Any positive current flow is prevented by second diode 15). The charge on second conducting enclosure 8 will cause a charge and voltage on second capacitor 10, which will enhance the responsivity of the system.

The current through diode 13 goes into a conversion circuit. This conversion circuit will convert the spiked voltage response caused by the discharging of current from conducting enclosure 4 into an oscillating sinusoidal voltage that can be used by common appliances. The conversion circuit shown is just one example of a conversion circuit that may be used. Any conversion circuit can be used that takes the output from diode 13 and converts it into a form that is usable. In the exemplified conversion circuit, an inductor 16, a capacitor 22, and a transformer 23 are used. 17 is a current source for the transformer 23. Possible loads, such as a city grid, household appliance, or an electric motor in a transportation device, among others, are connected to the output of the transformer 23.

In the embodiment shown, the output of the transformer 23 is additionally used to drive the second set of magnets 5 through a driving circuit consisting of resistors 20 and 19, the capacitor 21 and third diode 18. This driving circuit will provide an input for the two sets of magnets, 5 and 6.

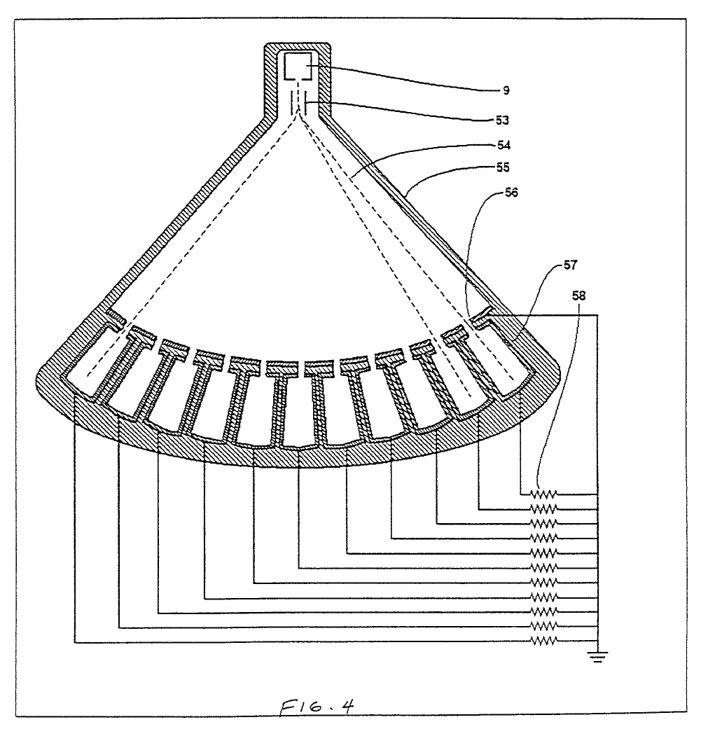

FIG. 4 shows an embodiment of the invention that can be used to generate heat in which a plurality of capacitors are used. An electron gun 9 which produces a very high cathode current, is used to generate an electron stream which is deflected by the static charge maintained on two deflector plates, 53. This static charge is varied over time to divert the cathode ray so that it will sweep cyclically between multiple entrapping capacitors 57, which are housed in a conducting enclosure 55. Any number of entrapping capacitors can be used. A grounded shield 56, is used to prevent voltage effects between neighboring capacitors. The entrapping capacitors can be discharged via resistors 58, to ground 50. The heat generated by the discharging resistors can be used for applications in which heating is desired, such as heating a home or to drive steam turbines. The resistance values of the resistors are chosen so that the discharge rate is such that each entrapping capacitor is completely discharged before the cathode ray is directed towards it to charge it again. 54 is a possible path of the output of the electron gun 9 to one or another of the plurality of capacitors 57.

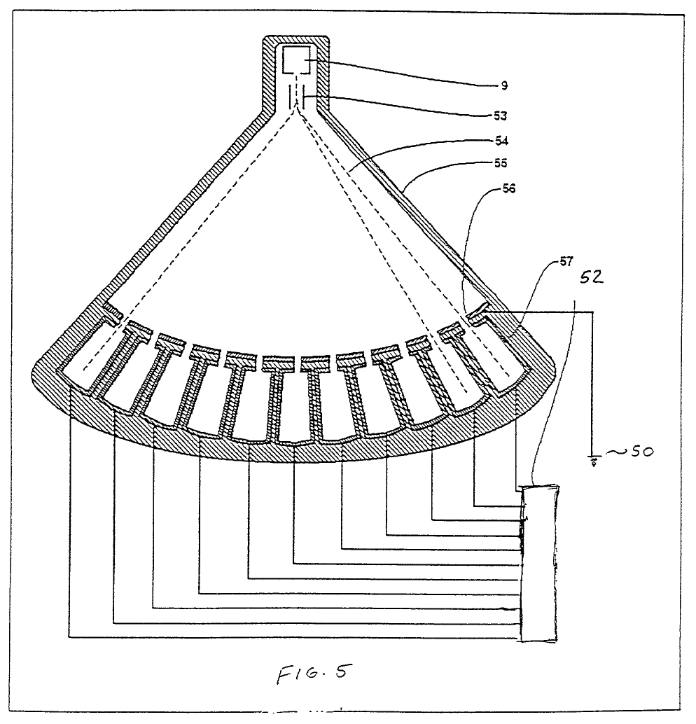

FIG. 5 shows an embodiment of the invention that can be used to generate electric current in which a plurality of capacitors are used. An electron gun 9, which produces a very high cathode current, is used to generate an electron stream which is deflected by the static charge maintained on two deflector plates 53. This static charge is varied over time to divert the cathode ray so that it will sweep cyclically between multiple entrapping capacitors 57 which are housed in a conducting enclosure, 55. Any number of entrapping capacitors can be used. A grounded shield 56, is used to prevent voltage effects between neighboring capacitors. The entrapping capacitors can be discharged via conversion circuitry 52, that converts the induced voltage on the entrapping capacitors into current that can be used by a variety of electronic devices, such as power generators or household appliances. 54 represents one of several paths of the output of the electron gun 9, and 50 is ground.

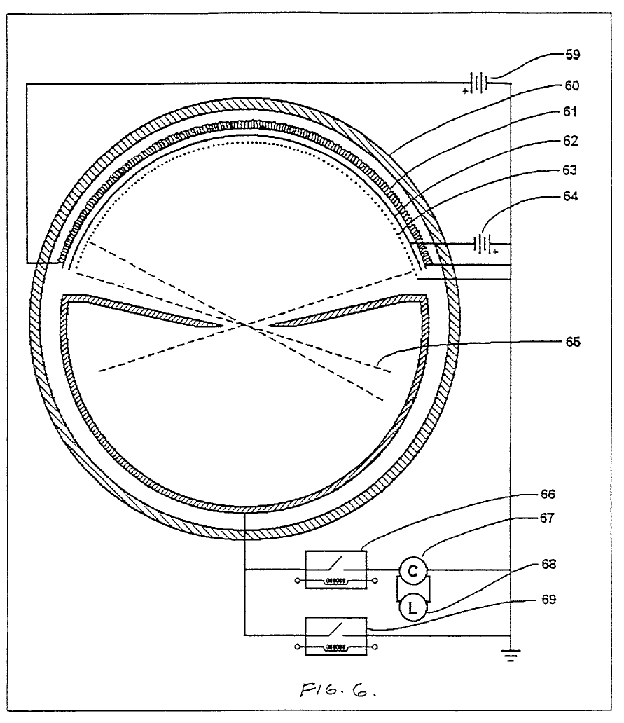

FIG. 6 shows an embodiment in which the electron gun 62 is a hemispherical cathode that focuses its output such that it is significantly captured by the conducting enclosure 70. The cathode can be heated metal coated by strontium or barium oxide and heated by a resistance heater. The acceleration voltage for this embodiment is low, being less than 100 Volts. The electrons freed from the cathode are accelerated through a wire grid, 63, which is maintained at a ground voltage. Due to the physical form of the cathode and the accelerating grid, the freed electrons will travel in such a way that they will converge upon the aperture of the entrapping capacitor. 65 represents the path of the electron stream from the electron gun into the enclosing capacitor. 59 and 64 are voltage sources, 61 is the heating element for the electron gun 62, and 63 represents the electrons generated by the electron gun 62. 60 encloses the entire system in a vacuum and 50 is ground. This embodiment has two phases.

During Phase I, the conducting enclosure 70 is discharged through a conversion circuit 80. This conversion circuit 80 converts the discharge current into an electric current that can be used by a variety of applications, such as a power grid, a household appliance, or any other electronic device. During Phase II, the cathode 62 generates electrons which collide with and are captured by the conducting enclosure 70.

1. A device comprising an electron gun positioned such that its output is directed towards a conducting enclosure.

2. The device of claim 1 further comprising an intermittently activatable magnetic bottle.

3. The device of claim 1 further comprising a focusing means placed such that the output of the electron gun can be significantly focused.

4. The device of claim 1 further comprising deflector plates.

5. The device of claim 1 further comprising acceleration plates.

6. The device of claim 1 further comprising voltage measurement and conversion means such that said device can be used to provide a voltage gain.

7. The device of claim 1 further comprising means for discharging said conducting enclosure and a conversion circuit such that said device can be used to provide an electric current.

8. The device of claim 1 further comprising a load such that said device can be used to provide heat.

9. The device of claim 1 wherein said conducting enclosure houses a plurality of capacitors.

10. The device of claim 1 wherein said electron gun is a semi-spherical cold cathode positioned such that its output is significantly convergent upon said conducting enclosure.

11. The device of claim 1 wherein a non-electronic means is used to power said electron gun such that it generates an output.

12. The device of claim 2 wherein said magnetic bottle is intermittently generated by a set of activatable magnets.

13. The device of claim 2 wherein said magnetic bottle is generated by a first set of passive magnets, generating a first magnetic field, and a second set of intermittently activatable magnets placed such that said second set generates a second magnetic field exactly opposing said first magnetic field.

14. The device of claim 3 wherein said focusing means is mobile.

15. The device of claim 6 wherein said voltage gain is approximately 500%.

16. A method comprising:
a) providing an electron gun able to generate an electron stream;
b) directing electrons from said electron stream towards a conducting enclosure;

17. The method of claim 16 further comprising:
a) activating a magnetic field to form a magnetic bottle within said conducting enclosure;
b) activating said electron gun concurrently with said magnetic field to produce an electron cloud within said magnetic bottle;
c) deactivating said magnetic field so that said electrons from said electron cloud are create a charge on said conducting enclosure;
d) connecting said conducting enclosure to a voltage measurement and conversion circuit to provide a voltage gain.

18. The method of claim 16 further comprising:
a) discharging said conducting enclosure through a load to generate heat;

19. The method of claim 16 further comprising:
a) discharging said conducting enclosure through a conversion circuit to provide an electric current.

20. The method of claim 18 wherein said electron gun is powered by non-electric means.

21. The method of claim 18 wherein said load is part of a home heating system.

22. The method of claim 19 further comprising:
a) activating a magnetic field to form a magnetic bottle within said conducting enclosure;
b) activating said electron gun concurrently with said magnetic field to produce an electron cloud within said magnetic bottle;
c) deactivating said magnetic field so that said electrons from said electron cloud are create a charge on said conducting enclosure;

23. The method of claim 19 wherein said electron gun is a semi-spherical cold cathode.

24. The method of claim 19 wherein said conducting enclosure houses a plurality of capacitors.

25. The method of claim 24 further comprising a mobile focusing means.

26. The method of claim 19 wherein said conversion circuit is connected so as to provide said electric current to electrically powered systems or devices selected from the group consisting of a means of transportation, a household appliance, a satellite, a city power grid, a greenhouse, a water purification system, and a waste disposal system.
